(19) United States
(12) Patent Application Publication
(10) Pub. No.: US 2025/0197613 A1
(43) Pub. Date: Jun. 19, 2025

(54) RUBBER COMPOSITION FOR TIRE TREAD AND TIRE

(71) Applicant: Toyo Tire Corporation, Itami-shi (JP)

(72) Inventor: Chi Zhang, Itami-shi (JP)

(73) Assignee: Toyo Tire Corporation, Itami-shi (JP)

(21) Appl. No.: 18/947,188

(22) Filed: Nov. 14, 2024

(30) Foreign Application Priority Data
Dec. 13, 2023 (JP) 2023-209766

(51) Int. Cl. C08L 7/00; B60C 1/00; C08L 9/00

(52) U.S. Cl. CPC C08L 7/00; B60C 1/0016; C08L 9/00; C08L 2205/035; C08L 2205/22; C08L 2207/324

(57) ABSTRACT

The rubber composition for a tire tread according to the embodiment contains 1 to 50 parts by mass of an aromatic resin which contains an aromatic vinyl compound as a constituent monomer and which is liquid at 23° C. per 100 parts by mass of a diene rubber. The rubber composition has an on-ice braking performance and a response performance on an icy road surface.

### BACKGROUND OF THE INVENTION

### 1. Field of the Invention

The present invention relates to a rubber composition for a tire tread and a tire using the same.

### 2. Description of Related Art

It is required that a rubber composition used for the tread of a tire, especially a studless tire, has improved grip performance on an icy road surface (on-ice braking performance).

For example, for the purpose of achieving both on-ice braking performance and grip performance on a wet road surface (wet grip performance), JP2021-091839A discloses a rubber composition containing a liquid diene rubber and porous cellulose particles. JP2024-090533A discloses that a terpene resin is added together with a liquid rubber and porous cellulose particles.

Moreover, for the purpose of improving the on-ice performance, JP2019-151743A discloses that a certain terpene resin and silica are added to a highly purified natural rubber.

### SUMMARY OF THE INVENTION

To meet the market's request which becomes greater recently, it is required that studless tires have not only on-ice braking performance but also excellent movement response, including suppression of wandering on an icy road surface, namely response performance.

JP2021-091839A, JP2024-090533A, and JP2019-151743A disclose that a terpene resin or a petroleum resin is added but do not suggest that a specific aromatic liquid resin is added.

An object of the embodiment of the invention is to provide a rubber composition for a tire tread having excellent on-ice braking performance and excellent response performance on an icy road surface and a tire using the same.

The invention includes the embodiments shown below.
[1] A rubber composition for a tire tread containing, per 100 parts by mass of a diene rubber, 1 to 50 parts by mass of an aromatic resin which contains an aromatic vinyl compound as a constituent monomer and which is liquid at 23° C.
[2] The rubber composition for a tire tread according to [1], wherein the glass transition temperature of the aromatic resin is −100° C. or higher and 0° C. or lower.
[3] The rubber composition for a tire tread according to [1] or [2], wherein the weight average molecular weight of the aromatic resin is 500 to 30,000.
[4] The rubber composition for a tire tread according to [1] or [2], wherein the weight average molecular weight of the aromatic resin is 500 to 2,000.
[5] The rubber composition for a tire tread according to any one of [1] to [4], wherein the aromatic resin contains at least one kind of aromatic vinyl compound selected from the group consisting of styrene, a-substituted styrene, ortho-substituted styrene, meta-substituted styrene, and para-substituted styrene as a constituent monomer.
[6] The rubber composition for a tire tread according to [5], wherein the aromatic resin further contains a (meth)acrylate as a constituent monomer.
[7] The rubber composition for a tire tread according to any one of [1] to [6] which further contains 0.3 to 20 parts by mass of porous cellulose particles per 100 parts by mass of the diene rubber.
[8] The rubber composition for a tire tread according to any one of [1] to [7], wherein 100 parts by mass of the diene rubber contains 20 to 65 parts by mass of an isoprene-based rubber and 10 to 55 parts by mass of a butadiene rubber.
[9] A tire having a tread formed with the rubber composition for a tire tread according to any one of [1] to [8].

According to an embodiment of the invention, excellent on-ice braking performance is obtained, and the response performance on an icy road surface can also be improved.

### DESCRIPTION OF EMBODIMENTS

The rubber composition for a tire tread according to the embodiment (also simply referred to as the rubber composition below) contains a diene rubber and an aromatic resin which contains an aromatic vinyl compound as a constituent monomer and which is liquid at 23° C. As a result, both on-ice braking performance and response performance on an icy road surface are obtained. The mechanism thereof is not clear, but it is speculated to be because tire softness and rigidity with a moderate balance are obtained due to the use of the aromatic resin which is liquid at normal temperature, although the mechanism is not intended to be limited thereto.

In the rubber composition according to the embodiment, the diene rubber used as a rubber component is a rubber having a repeating unit corresponding to a diene monomer having a conjugated double bond and contains a carbon-carbon double bond in the main chain of the polymer. As the diene rubber, a solid diene rubber is generally used. In the present specification, “solid” means having no fluidity at normal temperature of 23° C.

Specific examples of the diene rubber include an isoprene-based rubber such as natural rubber (NR) and synthetic isoprene rubber (IR), a butadiene rubber (BR), a styrene butadiene rubber (SBR), a nitrile rubber (NBR), a chloroprene rubber (CR), a styrene-isoprene copolymer rubber, a butadiene-isoprene copolymer rubber, a styrene-isoprene-butadiene copolymer rubber, and the like. The concept of these diene rubbers also includes those in which the terminal or the main chain has been modified according to the need (for example, terminal-modified SBR) and those modified to add a desired feature (for example, modified NR). Any one kind of these diene rubbers may be used, or two or more kinds thereof may be used in combination.

The diene rubber is preferably at least one kind selected from the group consisting of an isoprene-based rubber, a butadiene rubber, and a styrene butadiene rubber, more preferably an isoprene-based rubber and/or a butadiene rubber. In an embodiment, 100 parts by mass of the diene rubber preferably contains 20 to 65 parts by mass of an isoprene-based rubber (namely NR and/or IR) and 10 to 55 parts by mass of a butadiene rubber, more preferably contains 30 to 60 parts by mass of an isoprene-based rubber and 30 to 55 parts by mass of a butadiene rubber, and further preferably contains 45 to 60 parts by mass of an isoprene-based rubber and 40 to 55 parts by mass of a butadiene rubber. Here, as a residual rubber, for example, a styrene butadiene rubber may be contained optionally.

To the rubber composition according to the embodiment, a liquid aromatic resin containing an aromatic vinyl compound as a constituent monomer is added. The aromatic resin is a thermoplastic resin. Here, the thermoplastic resin means a resin having a feature of softening at a temperature of the glass transition temperature or the melting point or higher and solidifying at the glass transition temperature or the melting point or lower. In the embodiment, a liquid resin which is liquid at normal temperature is used. “Liquid at normal temperature” means having fluidity at 23° C.

The aromatic resin contains an aromatic vinyl compound as a constituent monomer. Here, containing as a constituent monomer means using as a raw material (monomer) for synthesizing the resin and having a structure derived therefrom in the resin. Examples of the aromatic vinyl compound include styrene, α-substituted styrene (for example, α-methylstyrene, or α-ethylenestyrene), ortho-substituted styrene (for example, o-methylstyrene, o-ethylstyrene, o-isopropylstyrene, or o-tert-butylstyrene), meta-substituted styrene (for example, m-methylstyrene, m-ethylstyrene, m-isopropylstyrene, or m-tert-butylstyrene), para-substituted styrene (for example, p-methylstyrene, p-ethylstyrene, p-isopropylstyrene, or p-tert-butylstyrene). Any one kind thereof may be used, or two or more kinds thereof may be used in combination.

The constituent monomer of the aromatic resin may be the aromatic vinyl compound alone, but may also be a copolymer of the aromatic vinyl compound and another monomer. The amount of the aromatic vinyl compound based on 100 mass % of the constituent monomers may be 10 mass % or more, 10 to 60 mass %, or 15 to 40 mass %.

Examples of the other monomer used with the aromatic vinyl compound as a constituent monomer include a (meth)acrylate, a fatty acid vinyl ester, indene, and the like. Of these, a (meth)acrylate and/or indene are preferably used. The amount of the (meth)acrylate and/or the indene based on 100 mass % of the constituent monomers is not particularly limited and may be 40 to 90 mass % or 60 to 85 mass %. Here, the (meth)acrylate means an acrylate and/or a methacrylate.

Examples of the (meth)acrylate include methyl (meth)acrylate, ethyl (meth)acrylate, butyl (meth)acrylate, octyl (meth)acrylate, decyl (meth)acrylate, lauryl (meth)acrylate, tetradecyl (meth)acrylate, hexadecyl (meth)acrylate, and stearyl (meth)acrylate. Any one kind thereof may be used, or two or more kinds thereof may be used in combination. Of these, an ester of (meth)acrylic acid and an alcohol having 10 or more carbon atoms is preferably used, and an ester of (meth)acrylic acid and an alcohol having 10 or more and 18 or less carbon atoms is more preferably used. Here, the (meth)acrylic acid means acrylic acid and/or methacrylic acid.

In an embodiment, the aromatic resin is preferably a copolymer containing the aromatic vinyl compound and the (meth)acrylate as constituent monomers. More preferably, 100 mass % of the constituent monomers contain 10 to 60 mass % of the aromatic vinyl compound and 40 to 90 mass % of the (meth)acrylate and further preferably contain 15 to 40 mass % of the aromatic vinyl compound and 60 to 85 mass % of the (meth)acrylate.

In an embodiment, the aromatic resin is preferably a copolymer containing the aromatic vinyl compound, the (meth)acrylate, and indene as constituent monomers. More preferably, 100 mass % of the constituent monomers contain 10 to 50 mass % of the aromatic vinyl compound, 40 to 80 mass % of the (meth)acrylate, and 10 to 50 mass % of indene and further preferably contain 15 to 30 mass % of the aromatic vinyl compound, 50 to 70 mass % of the (meth)acrylate, and 15 to 30 mass % of indene.

The glass transition temperature (Tg) of the aromatic resin is preferably −100° C. or higher and 0° C. or lower. When the glass transition temperature is 0° C. or lower, the effect of improving the on-ice braking performance can be enhanced. When the glass transition temperature is −100° C. or higher, the effect of improving the response performance on an icy road surface can be enhanced. The glass transition temperature of the aromatic resin is more preferably −90° C. to −5° C., further preferably −50° C. to −10° C., and may be −30° C. to −10° C. The glass transition temperature can be determined by the measurement method described in the section of the Examples.

The weight average molecular weight (Mw) of the aromatic resin is preferably 500 to 30,000 (g/mol). When the weight average molecular weight is 30,000 or less, the effect of improving the on-ice braking performance and the response performance on an icy road surface can be enhanced. The weight average molecular weight of the aromatic resin is more preferably 20,000 or less. In view of further improving the balance of the on-ice braking performance and the response performance on an icy road surface, the aromatic resin preferably has a low molecular weight. Specifically, the weight average molecular weight of the aromatic resin is preferably 500 to 2,000, more preferably 600 to 1,500. The weight average molecular weight can be determined by the measurement method described in the section of the Examples.

The aromatic resin content, per 100 parts by mass of the diene rubber, is 1 to 50 parts by mass, preferably 3 to 40 parts by mass, more preferably 5 to 35 parts by mass, further preferably 10 to 25 parts by mass, further preferably 10 to 20 parts by mass.

Porous cellulose particles are preferably added to the rubber composition according to the embodiment, and the on-ice braking performance can be thus improved. The porous cellulose particle content, per 100 parts by mass of the diene rubber, is preferably 0.3 to 20 parts by mass, more preferably 0.5 to 15 parts by mass, further preferably 1 to 10 parts by mass.

The porosity of the porous cellulose particles is not particularly limited and is, for example, preferably 75 to 95%, more preferably 85 to 95%. Here, the porosity of the porous cellulose particles can be determined by the following equation after measuring the volume of a certain mass of the sample (namely, the porous cellulose particles) with a measuring cylinder and determining the bulk specific gravity. Here, the absolute specific gravity of cellulose is 1.5.

Porosity [%]={1−(bulk specific gravity [g/ml] of sample)/(absolute specific gravity [g/ml] of sample)}×100

The average particle size of the porous cellulose particles is not particularly limited and is, for example, preferably 1000 μm or less, more preferably 100 to 800 μm, further preferably 200 to 800 μm.

The porous cellulose particles are preferably spherical particles having a ratio of longest diameter/shortest diameter of 1 to 2, and the ratio of longest diameter/shortest diameter is more preferably 1 to 1.5, further preferably 1 to 1.2. When such particles having a spherical structure are used, the dispersibility in the rubber composition improves, and excellent on-ice braking performance is obtained easily.

The average particle size and the ratio of longest diameter/shortest diameter of the porous cellulose particles are determined as follows. That is, the porous cellulose particles are observed with a microscope, and an image is obtained. Using the image, the longest diameters and the shortest diameters (when the longest diameter and the shortest diameter are the same, the length in an axial direction and the length in the orthogonal axial direction) of 100 particles are measured, and the average is calculated. As a result, the average particle size is obtained. Moreover, the ratio of longest diameter/shortest diameter is obtained by taking an average of the values obtained by dividing the longest diameters by the shortest diameters.

Such porous cellulose particles are commercially available, for example, as “Viscopearl” (registered trademark) from Rengo Co., Ltd. and also described in JP2001-323095A and JP2004-115284A, and these porous cellulose particles can be suitably used. Specifically, cellulose particles obtained by adding a pore-forming agent (a carbonate such as calcium carbonate) to an alkaline cellulose solution such as viscose and simultaneously advancing solidification/regeneration of cellulose and foaming with the pore-forming agent are preferably used.

A reinforcing filler may be added to the rubber composition according to the embodiment. The reinforcing filler content is not particularly limited and may be, for example, per 100 parts by mass of the diene rubber, 40 to 120 parts by mass, 50 to 100 parts by mass, or 50 to 80 parts by mass.

The reinforcing filler is, for example, silica and/or carbon black. The silica is not particularly limited, and for example, wet silica such as wet-precipitated silica and wet-gelled silica may be used. The silica content is not particularly limited and is, for example, per 100 parts by mass of the diene rubber, preferably 20 to 100 parts by mass, more preferably 30 to 80 parts by mass.

The carbon black is not particularly limited, and various known kinds can be used. The carbon black content is not particularly limited and may be, for example, per 100 parts by mass of the diene rubber, 1 to 30 parts by mass or 1 to 20 parts by mass.

When silica is added to the rubber composition, a silane coupling agent is preferably further contained. In this case, the silane coupling agent content, per 100 parts by mass of the silica, is preferably 1 to 20 parts by mass, more preferably 2 to 15 parts by mass.

An oil may be added to the rubber composition according to the embodiment. Examples of the oil include mineral oils such as paraffin oil and aroma oils. The oil content is not particularly limited and may be, per 100 parts by mass of the diene rubber, 0 to 30 parts by mass or 5 to 25 parts by mass.

An additive which is generally used for a rubber composition, such as zinc oxide, stearic acid, wax, an antioxidant, a vulcanizing agent, and a vulcanization accelerator, may be added to the rubber composition according to the embodiment as an optional component in addition to the above components.

The zinc oxide content is not particularly limited and may be, for example, per 100 parts by mass of the diene rubber, 0 to 10 parts by mass, 0.5 to 5 parts by mass, or 1 to 4 parts by mass.

The stearic acid content is not particularly limited and may be, for example, per 100 parts by mass of the diene rubber, 0 to 10 parts by mass, 0.5 to 5 parts by mass, or 1 to 4 parts by mass.

The wax content is not particularly limited and may be, for example, per 100 parts by mass of the diene rubber, 0 to 10 parts by mass, 0.5 to 5 parts by mass, or 1 to 4 parts by mass.

Examples of the antioxidant include various antioxidants such as amine-ketone-based, aromatic secondary amine-based, monophenol-based, bisphenol-based, and benzimidazole-based antioxidants, and any one kind thereof or a combination of two or more kinds thereof can be used. The antioxidant content is not particularly limited and may be, for example, per 100 parts by mass of the diene rubber, 0 to 10 parts by mass or 1 to 5 parts by mass.

As the vulcanizing agent, sulfur is preferably used. The vulcanizing agent content is not particularly limited but may be, per 100 parts by mass of the diene rubber, 0.1 to 10 parts by mass, 0.5 to 5 parts by mass, or 1 to 3 parts by mass.

Examples of the vulcanization accelerator include various vulcanization accelerators such as sulfenamide-based, guanidine-based, thiuram-based, and thiazole-based vulcanization accelerators, and any one kind thereof alone or a combination of two or more kinds thereof can be used. The vulcanization accelerator content is not particularly limited but is, per 100 parts by mass of the diene rubber, preferably 0.1 to 7 parts by mass, more preferably 0.5 to 5 parts by mass, and may also be 1 to 4 parts by mass.

The rubber composition according to the embodiment can be produced by kneading using a generally used mixer such as a Banbury mixer, a kneader, and a roll according to a general method. That is, for example, the additives excluding the vulcanizing agent and the vulcanization accelerator are added to and mixed in the diene rubber together with the aromatic resin in a first mixing stage (non-productive kneading process). Next, the vulcanizing agent and the vulcanization accelerator are added to and mixed in the obtained mixture in a final mixing stage (productive kneading process). As a result, an unvulcanized rubber composition can be prepared.

The rubber composition according to the embodiment can be applied to the tread of pneumatic tires of various sizes for various applications, such as tires of passenger cars and large-sized tires of trucks and busses. The rubber composition is preferably used as a rubber composition for the tread of a studless tire. A pneumatic tire can be produced by producing a tread member with a rubber extruder or the like using the rubber composition, assembling with other tire members to form an unvulcanized tire (green tire), and then vulcanizing and molding, for example at 140 to 180° C., according to a normal method. In the case of application to a studless tire having a cap/base structure, the rubber composition according to the embodiment may be applied to the cap tread on the contact patch side only.

### EXAMPLES

Examples are shown below, but the invention is not limited to these Examples.

### Synthesis of Resins

### Synthetic Example 1: Resin 1

A magnetic stirrer tip, a thermometer, and a reflux condenser were attached to a 5000-ml separable four-neck flask. To the flask, 300 g of α-methylstyrene, 700 g of lauryl acrylate, and 2400 ml of methylcyclohexane were put as a reaction mixture and thoroughly stirred. A boron trifluoride phenol complex in an amount of 9.0 g and 90 g of toluene were put in a dropping funnel as catalysts, and the dropping funnel was attached to the flask. The uniformly dispersed reaction mixture was maintained at 1 to 3° C. using an alcohol bath cooled with dry ice, and the catalysts were added dropwise thereto over 15 minutes to initiate the polymerization reaction. After the completion of the dropwise addition of the catalysts, the reaction mixture was further polymerized for an hour while the reaction mixture was maintained at 1 to 3° C., and then the polymerization was terminated by adding an aqueous 0.5 N sodium hydroxide solution to the reaction mixture. The obtained product was washed with 1000 ml of water, and then the solvent and the unreacted monomers were removed by distillation under reduced pressure. Thus, a liquid resin 1 was obtained. The obtained resin 1 was an aromatic thermoplastic resin which was liquid at normal temperature and had a glass transition temperature Tg of −18° C., a number average molecular weight (Mn) of 470, and a weight average molecular weight (Mw) of 880.

### Synthetic Example 2: Resin 2

A liquid resin 2 was obtained in the same manner as in Synthetic Example 1 except that the monomers were 200 g of α-methylstyrene and 800 g of lauryl methacrylate. The obtained resin 2 was an aromatic thermoplastic resin which was liquid at normal temperature and had a glass transition temperature Tg of −90° C., a number average molecular weight (Mn) of 590, and a weight average molecular weight (Mw) of 920.

### Synthetic Example 3: Resin 3

A liquid resin 3 was obtained in the same manner as in Synthetic Example 1 except that the monomers were 200 g of p-methylstyrene, 200 g of indene, and 600 g of lauryl methacrylate. The obtained resin 3 was an aromatic thermoplastic resin which was liquid at normal temperature and had a glass transition temperature Tg of −6° C., a number average molecular weight (Mn) of 430, and a weight average molecular weight (Mw) of 750.

### Synthetic Example 4: Resin 4

A magnetic stirrer tip, a thermometer, and a reflux condenser were attached to a 5000-ml separable four-neck flask. To the flask, 300 g of α-methylstyrene, 700 g of lauryl acrylate, 6.870 g of azobisisobutyronitrile, and 2400 ml of toluene were put as a reaction mixture and thoroughly stirred. After bubbling with nitrogen for an hour, the reaction solution was maintained at 70° C. for 24 hours. Methanol was added to the reaction solution for reprecipitation, and after the obtained product was washed with 1000 ml of water, the solvent and the unreacted monomers were removed by distillation under reduced pressure. Thus, a liquid resin 4 was obtained. The obtained resin 4 was an aromatic thermoplastic resin which was liquid at normal temperature and had a glass transition temperature Tg of −15° C., a number average molecular weight (Mn) of 12,000, and a weight average molecular weight (Mw) of 20,000.

### Synthetic Example 5: Resin 5

A liquid resin 5 was obtained in the same manner as in Synthetic Example 1 except that the monomers were 800 g of lauryl acrylate and 200 g of lauryl methacrylate. The obtained resin 5 was an aliphatic thermoplastic resin which did not contain any aromatic ring and which was liquid at normal temperature and had a glass transition temperature Tg of −80° C., a number average molecular weight (Mn) of 500, and a weight average molecular weight (Mw) of 1,100.

### Measurement Method of Glass Transition Temperature

Measurement was made in accordance with JIS K7121:2012 by the differential scanning calorimetry (DSC) at a heating rate of 20° C./minute (measurement temperature range: −150° C. to 80° C.).

### Measurement Method of Average Molecular Weights

The weight average molecular weights (Mw) and the number average molecular weights (Mn) were determined by measurement by gel permeation chromatography (GPC) in terms of polystyrene. Specifically, as a measurement sample, a sample obtained by dissolving 10 mg of the resin in 5 mL of tetrahydrofuran was used. The sample was caused to pass through a filter and then pass through a column (manufactured by Agilent Technologies, Inc., PLgel GUARD 5 μm 50×7.5 mm+PLgel 50 Å 5 μm 300×7.5 mm+PLgel 100 Å 5 μm 300×7.5 mm+PLgel 500 Å 5 μm 300×7.5 mm) at a temperature of 40° C. and a flow rate of 1.0 mL/minute using “Nexera” manufactured by SHIMADZU CORPORATION and was detected with a differential refractometer, and the molecular weights were calculated in terms of polystyrene using commercial standard polystyrene.

### Preparation of Rubber Compositions

Using a laboratory mixer, in accordance with the composition (parts by mass) shown in Table 1 below, first, the agents to be added excluding sulfur and the vulcanization accelerators were added to and kneaded in the diene rubber in a first mixing stage (discharge temperature=160° C.). Next, sulfur and the vulcanization accelerators were added to and kneaded in the obtained kneaded material in a final mixing stage (discharge temperature=90° C.), and a rubber composition was thus prepared. The details of the components in Table 1 are as follows.
NR: RSS #3
BR: “BR730” manufactured by ENEOS Materials Corporation
Porous cellulose particles: “Viscopearl Mini” manufactured by Rengo Co., Ltd. (average particle size=400 μm, ratio of longest diameter/shortest diameter of particles=1.11, porosity=87%)
Silica: “Nipsil AQ” manufactured by Tosoh Silica Corporation
Silane coupling agent: “Si-75” manufactured by Evonik
Carbon black: “Seast 7HM” manufactured by TOKAI CARBON CO., LTD.
Zinc oxide: “Zinc Oxide, Type 2” manufactured by MITSUI MINING & SMELTING CO., LTD.
Stearic acid: “Lunac S-20” manufactured by Kao Corporation
Wax: “OZOACE0355” manufactured by NIPPON SEIRO CO., LTD.
Antioxidant: “Nocrac 6C” manufactured by OUCHI SHINKO CHEMICAL INDUSTRIAL CO., LTD.
Oil: “Process P200” manufactured by ENEOS Corporation
Vulcanization accelerator 1: “Soxinol CZ” manufactured by Sumitomo Chemical Co., Ltd.
Vulcanization accelerator 2: “Nocceler DZ-G” manufactured by OUCHI SHINKO CHEMICAL INDUSTRIAL CO., LTD.
Sulfur: “Powder Sulfur” manufactured by Tsurumi Chemical Industry Co., ltd.
Terpene resin: solid, “SYLVATRAXX 4150” manufactured by Kraton Corporation
Resin 1: Liquid aromatic resin (Tg: −18° C., Mw: 880)
Resin 2: Liquid aromatic resin (Tg: −90° C., Mw: 920)
Resin 3: Liquid aromatic resin (Tg: −6° C., Mw: 750)
Resin 4: Liquid aromatic resin (Tg: −15° C., Mw: 20000)
Resin 5: Liquid aliphatic resin (Tg: −80° C., Mw: 1100)
Resin 6: Solid aromatic resin, C5/C9 resin, “Petrotack 90” manufactured by Tosoh Corporation (Tg: 55° C., Mw: 1700)
Resin 7: Solid aromatic resin, styrene resin, “SYLVATRAXX 4401” manufactured by Kraton Corporation (Tg: 50° C., Mw: 1020)

Studless tires (tire size: 195/65R15) in which the obtained rubber compositions were applied to the treads were produced, and the on-ice braking performance and the response performance on an icy road surface were evaluated. The evaluation method is as follows.

### On-Ice Braking Performance

The studless tires were mounted on a 2000-cc 4WD car. ABS was activated at an air temperature of −2° C. to −6° C. at a speed of 40 km/h, and the braking distance (the average of n=10) on the ice was measured. The reciprocal of the measured braking distance was expressed with an index, where the value of Comparative Example 1 was regarded as 100. As the index becomes higher, the braking distance becomes shorter, showing that the on-ice braking performance is excellent.

### Response Performance

A driver in charge of the sensory test drove on a test course with an icy road surface at an air temperature of −2° C. to −6° C. while paying attention to the control response, the running stability (wandering), and the like and made sensory evaluation of the response performance (evaluation of the feeling performance). The results are shown in Table 1, where +2 was given to one which was superior, +1 was given to one which was slightly superior, ±0 was given to one which was equivalent, −1 was given to one which was slightly inferior, and −2 was given to one which was inferior, compared to Comparative Example 1 as the control.

TABLE 1

| | Comp. | | | | | | | Comp. | Comp. | Comp. |
|---|---|---|---|---|---|---|---|---|---|---|
| | Ex. 1 | Ex. 1 | Ex. 2 | Ex. 3 | Ex. 4 | Ex. 5 | Ex. 6 | Ex. 2 | Ex. 3 | Ex. 4 |
| Composition (parts by mass) | | | | | | | | | | |
| NR | 50 | 50 | 50 | 50 | 50 | 50 | 50 | 50 | 50 | 50 |
| BR | 50 | 50 | 50 | 50 | 50 | 50 | 50 | 50 | 50 | 50 |
| Porous cellulose particles | 2 | 2 | 2 | 2 | 2 | 2 | 2 | 2 | 2 | 2 |
| Silica | 50 | 50 | 50 | 50 | 50 | 50 | 50 | 50 | 50 | 50 |
| Silane coupling agent | 3.5 | 3.5 | 3.5 | 3.5 | 3.5 | 3.5 | 3.5 | 3.5 | 3.5 | 3.5 |
| Carbon black | 9 | 9 | 9 | 9 | 9 | 9 | 9 | 9 | 9 | 9 |
| Zinc oxide | 2 | 2 | 2 | 2 | 2 | 2 | 2 | 2 | 2 | 2 |
| Stearic acid | 2 | 2 | 2 | 2 | 2 | 2 | 2 | 2 | 2 | 2 |
| Wax | 1.5 | 1.5 | 1.5 | 1.5 | 1.5 | 1.5 | 1.5 | 1.5 | 1.5 | 1.5 |
| Antioxidant | 4 | 4 | 4 | 4 | 4 | 4 | 4 | 4 | 4 | 4 |
| Oil | 20 | 20 | 20 | 20 | 20 | 20 | 20 | 20 | 20 | 20 |
| Terpene resin (solid) | 10 | | | | | | | | | |
| Resin 1 (aromatic, liquid) | | 10 | | | 20 | 30 | | | | |
| Resin 2 (aromatic, liquid) | | | 10 | | | | | | | |
| Resin 3 (aromatic, liquid) | | | | 10 | | | | | | |
| Resin 4 (aromatic, liquid) | | | | | | | 10 | | | |
| Resin 5 (aliphatic, liquid) | | | | | | | | 10 | | |
| Resin 6 (solid) | | | | | | | | | 10 | |
| Resin 7 (solid) | | | | | | | | | | 10 |
| Vulcanization accelerator 1 | 0.9 | 0.9 | 0.9 | 0.9 | 0.9 | 0.9 | 0.9 | 0.9 | 0.9 | 0.9 |
| Vulcanization accelerator 2 | 1.1 | 1.1 | 1.1 | 1.1 | 1.1 | 1.1 | 1.1 | 1.1 | 1.1 | 1.1 |
| Sulfur | 1.4 | 1.4 | 1.4 | 1.4 | 1.4 | 1.4 | 1.4 | 1.4 | 1.4 | 1.4 |
| Evaluation | | | | | | | | | | |
| On-ice braking performance | 100 | 105 | 106 | 104 | 108 | 103 | 100 | 103 | 98 | 99 |
| Response performance | Control | +2 | +1 | +2 | +1 | +1 | +1 | −2 | −1 | −1 |

Comparative Example 1 is a control composition to which a terpene resin that was solid at normal temperature was added and which had excellent on-ice braking performance. Examples 1 to 6, to which aromatic resins that were liquid at normal temperature were added instead of the terpene resin, could improve the response performance while maintaining or improving the excellent on-ice braking performance, compared to those of Comparative Example 1.

From the comparison among Examples 1, 4, and 5, the on-ice braking performance was improved by increasing the amount of the aromatic resin which was liquid at normal temperature, but the balance of the on-ice braking performance and the response performance did not improve anymore at an addition amount of around 30 phr. Accordingly, considering the balance, a more preferable addition amount is believed to be 10 to 20 phr. Regarding the molecular weight of the aromatic resin, while the response performance improved in Example 6 using the resin 4 having a high molecular weight, compared to that of Comparative Example 1, better results were obtained in Examples 1 to 3 having lower molecular weights, considering the balance with the on-ice braking performance.

On the other hand, in Comparative Example 2, in which a liquid aliphatic resin without having any aromatic ring was used instead of the terpene resin, the on-ice braking performance was superior to that of Comparative Example 1, but the response performance was clearly inferior. Moreover, in Comparative Examples 3 and 4, to which solid aromatic resins were added instead of the terpene resin, no effect of improving the response performance compared to that of Comparative Example 1 was observed.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

What is claimed is:

1. A rubber composition for a tire tread, comprising,
per 100 parts by mass of a diene rubber,
1 to 50 parts by mass of an aromatic resin which contains an aromatic vinyl compound as a constituent monomer and which is liquid at 23° C.

2. The rubber composition for a tire tread according to claim 1,
wherein the glass transition temperature of the aromatic resin is −100° C. or higher and 0° C. or lower.

3. The rubber composition for a tire tread according to claim 1,
wherein the weight average molecular weight of the aromatic resin is 500 to 30,000.

4. The rubber composition for a tire tread according to claim 1,
wherein the weight average molecular weight of the aromatic resin is 500 to 2,000.

5. The rubber composition for a tire tread according to claim 1,
wherein the aromatic resin contains at least one kind of aromatic vinyl compound selected from the group consisting of styrene, α-substituted styrene, ortho-substituted styrene, meta-substituted styrene, and para-substituted styrene as a constituent monomer.

6. The rubber composition for a tire tread according to claim 5,
wherein the aromatic resin further contains a (meth)acrylate as a constituent monomer.

7. The rubber composition for a tire tread according to claim 6,
wherein 100 mass % of the constituent monomers of the aromatic resin contain 10 to 60 mass % of the aromatic vinyl compound and 40 to 90 mass % of the (meth)acrylate.

8. The rubber composition for a tire tread according to claim 6,
wherein the aromatic resin further contains indene as a constituent monomer.

9. The rubber composition for a tire tread according to claim 8,
wherein 100 mass % of the constituent monomers of the aromatic resin contain 10 to 50 mass % of the aromatic vinyl compound, 40 to 80 mass % of the (meth)acrylate, and 10 to 50 mass % of the indene.

10. The rubber composition for a tire tread according to claim 1 which further comprises 0.3 to 20 parts by mass of porous cellulose particles per 100 parts by mass of the diene rubber.

11. The rubber composition for a tire tread according to claim 1,
wherein 100 parts by mass of the diene rubber contains 20 to 65 parts by mass of an isoprene-based rubber and 10 to 55 parts by mass of a butadiene rubber.

12. A tire comprising a tread formed with the rubber composition for a tire tread according to claim 1.
